(19) United States
(12) Patent Application Publication
(10) Pub. No.: US 2019/0128313 A1
(43) Pub. Date: May 2, 2019

(54) COMPONENT FASTENING STRUCTURE

(71) Applicant: TOYOTA JIDOSHA KABUSHIKI KAISHA, Toyota-shi (JP)

(72) Inventors: Yu OKUYAMA, Toyota-shi (JP); Eiji YOSHIDA, Seto-shi (JP)

(73) Assignee: TOYOTA JIDOSHA KABUSHIKI KAISHA, Toyota-shi (JP)

(21) Appl. No.: 16/171,736

(22) Filed: Oct. 26, 2018

(30) Foreign Application Priority Data
Nov. 2, 2017 (JP) 2017-212549

(51) Int. Cl. F16B 39/282; F16B 5/02

(52) U.S. Cl. CPC F16B 39/282; B61D 17/00; F16B 5/02

(57) ABSTRACT

A component fastening structure has a first component and a second component connected by a bolt and a nut. The first component includes a through hole through which a bolt is inserted, a seating face on which the bolt head is mounted near an upper end opening of the through hole, two rotation preventing wall portions which are formed near the seating face at both sides of the head to position the head between them, and lifting suppressing portions which are formed at positions apart above the seating face on the individual rotation preventing wall portions and protruded toward the head side. The interval between the two rotation preventing wall portions is smaller than the distance between the tip ends of two arm parts formed on the bolt head, and the seating face sides of the lifting suppressing portions are opposed to the upper surfaces of the arm parts.

### CROSS REFERENCE TO RELATED APPLICATION

The entire disclosure of Japanese Patent Application No. 2017-212549 filed on Nov. 2, 2017, including the specification, claims, drawings, and abstract, is incorporated herein by reference in its entirety.

### TECHNICAL FIELD

The present disclosure relates to a component fastening structure in which a first component and a second component are connected by a bolt and a nut.

### BACKGROUND

JP 2007-137217 A discloses a body structure for a railroad vehicle in which a rail member is connected to the upper side of a base frame of a lower end portion, a rectangular plate-like head of a special bolt is mounted inside the rail member, and the special bolt is used to mount a seating member.

In the component fastening structure using the special bolt and the rail member described in JP 2007-137217 A, it is considered to have a structure to connect a component to the rail member by a bolt and a nut using an upside-down structure. According to this structure, when the rectangular plate-like head is rotated, it is abutted against the inner surface of the rail, so that the bolt rotation may be prevented when the nut is fastened to the bolt. However, it is necessary to slide the bolt head laterally into the rail member, so that an opening through which the shaft portion of the bolt is inserted is open in a longitudinal direction along the overall length of the rail member. Thus, in the rail member, rigidity of a portion including a seating face on which the bolt head is pressed is deteriorated. Also, in a case where the bolt head is provided at a position higher than the shaft portion and the height of the rail member is considerably large in comparison with the height of the bolt head, the bolt is pushed upward when the nut is connected to the lower side of the shaft portion, and the head may be lifted up from the rail member. Thus, work of connecting the bolt and the nut may become difficult.

The present disclosure provides a component fastening structure in which two components are connected by a bolt and a nut, rigidity of a component on which a bolt head is mounted can be improved, the bolt can be prevented from rotating, and the bolt head can be suppressed from being lifted from the component.

### SUMMARY

The component fastening structure of the present disclosure is a component fastening structure in which a first component and a second component are mutually connected by a bolt and a nut, wherein the first component includes a through hole through which a shaft portion of the bolt is inserted vertically, a seating face on which the head of the bolt is mounted near an upper end opening of the through hole, two rotation preventing wall portions which are formed near the seating face at both sides of the head to position the head between them, and two lifting suppressing portions which are formed at positions apart above the seating face on the two rotation preventing wall portions and protruded at least partly toward the head side; the bolt includes two arm parts which are formed on the head to protrude in mutually opposite directions on a straight line orthogonal to the axial direction of the bolt; an interval between the two rotation preventing wall portions is smaller than a distance between tip ends of the two arm parts; and the seating face sides of the two lifting suppressing portions are opposed to the upper surfaces of the two arm parts.

According to the above configuration, in a case where the bolt rotates when the nut is fastened to the bolt, the bolt rotation can be prevented by the engagement between the arm parts formed on the bolt head and the rotation preventing wall portions. Simultaneously, in the first component, the through hole through which the shaft portion of the bolt is inserted can be formed to have a small circular hole, so that rigidity of the portion containing the seating face of the first component can be improved. In addition, the upper surfaces of the arm parts formed on the head are abutted against the seating face sides of the lifting suppressing portions, and the head can be suppressed from being lifted from the seating face.

In the component fastening structure of this disclosure, the first component can be integrally made of metal or resin, the two rotation preventing wall portions can be two first ribs formed on the first component, and the two lifting suppressing portions can be two second ribs which are formed continuously to the two first ribs.

According to the above configuration, the number of assembling processes and the number of components for the first component can be reduced by the first component including the two rotation preventing wall portions and the two lifting suppressing portions being integrally made of metal or resin. Simultaneously, the first component is easily realized to have a structure in which a portion requiring local strength is made thick.

According to the component fastening structure of the present disclosure, it has a structure in which two components are mutually connected by a bolt and a nut, rigidity of a component on which the bolt head is mounted can be improved, the bolt can be prevented from rotating, and the bolt head can be suppressed from being lifted from the component.

### BRIEF DESCRIPTION OF THE DRAWINGS

Embodiment(s) of the present disclosure will be described based on the following figures, wherein:

FIG. 1 is a sectional view of a vehicle including a component fastening structure of an embodiment according to the present disclosure while omitting a part of the structure;

FIG. 2 is a view of a vehicle observed from the rear side with a radiator support, shock absorbing members and bolts as a first component taken out from FIG. 1;

FIG. 3 is a view of point A in FIG. 2 observed obliquely from above;

FIG. 4 is a perspective view of a bolt;

FIG. 5 is an enlarged B-B sectional view of FIG. 1;

FIG. 6 is a top view of FIG. 5;

FIG. 7 is a view showing a state where the bolt is rotated in FIG. 6 and arm parts are engaged with first ribs; and

FIG. 8 is a view of another example of the embodiment of the present disclosure and corresponds to the upper part of FIG. 5.

### DESCRIPTION OF EMBODIMENTS

Embodiments of the present disclosure are described below with reference to the drawings. Shapes, materials, and numbers described below are illustrative only for the description and can be changed appropriately depending on the specifications of a vehicle including the component fastening structure. A case where the component fastening structure is applied to a connection structure of a radiator support as a first component and a mount member as a second component is described below, but the present disclosure is not limited to the above and can be applied to a structure to connect two components vertically. It is noted in the following description that like elements will be denoted by the same reference numerals in all the figures. Also, the following description uses the same reference numerals used previously, as necessary.

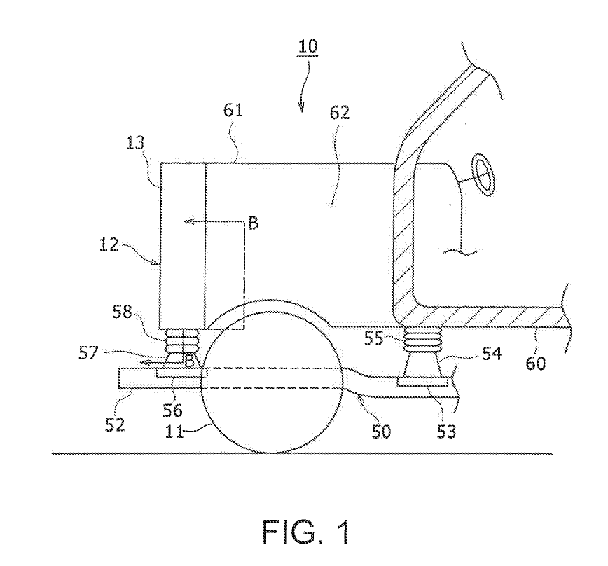

FIG. 1 is a sectional view showing a vehicle 10 including a component fastening structure 12 of the embodiment while omitting a part of the structure. The vehicle 10 is a vehicle with a frame, and a cab 60 is connected to the upper side of a ladder frame 50. The ladder frame 50 is constituted to include two side frames 52 which are separately arranged on both sides in a width direction of the vehicle 10 (in the front and back directions of FIG. 1 sheet), and a plurality of cross members (not shown). The individual side frames 52 as a whole are arranged to extend in the longitudinal direction (in the lateral direction of FIG. 1) of the vehicle 10. The individual cross members as a whole are arranged along the vehicle width direction and fixed to the two side frames 52. A wheel 11 is suspended on the front and rear sides of the individual side frames 52 in the vehicle longitudinal direction.

In addition, a plate-like intermediate bracket 53 is fixed at an intermediate part of the individual side frames 52 in the vehicle longitudinal direction. The intermediate bracket 53 is connected with the cab 60 via a mount member 54 and a rubber-made shock absorbing member 55. A driver's seat (not shown) is provided in the cab 60.

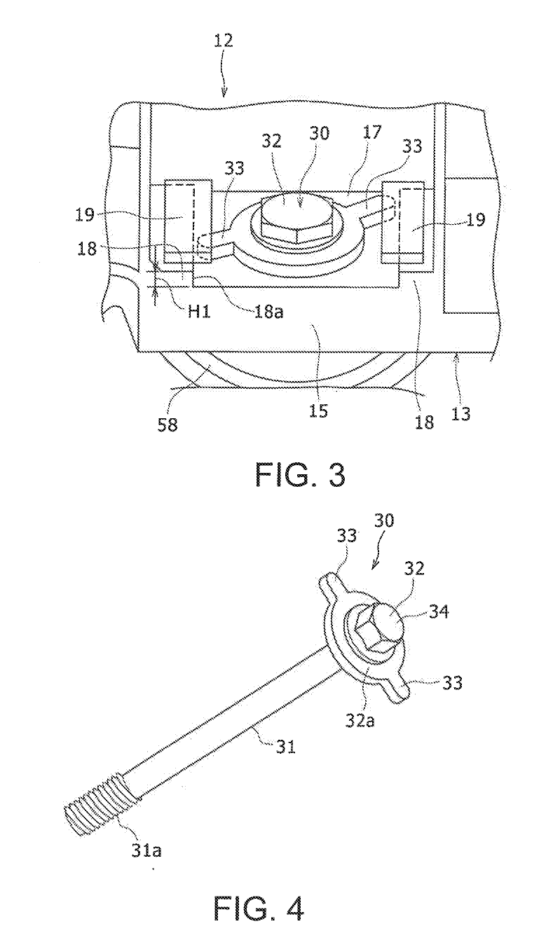

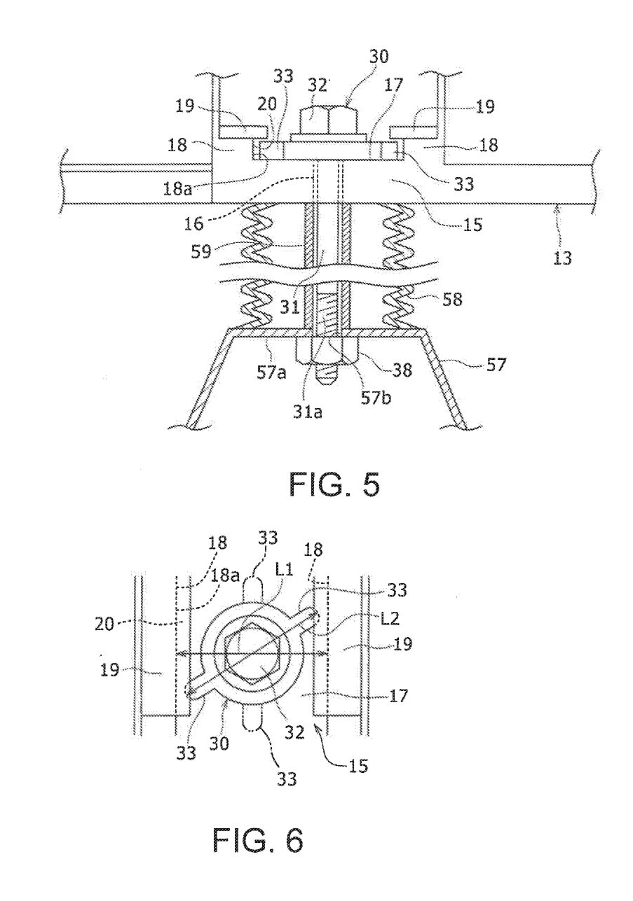

A plate-like front bracket 56 is fixed to a vehicle front end section (left end section in FIG. 1) of the individual side frames 52. A radiator support 13 is connected to the front bracket 56 via a mount member 57 and a rubber-made shock absorbing member 58. Specifically, the mount member 57 is fixed to the upper side of the individual front brackets 56 by welding or a fastening means including a bolt. The radiator support 13 is fixed to the mount member 57 via the shock absorbing member 58 by a bolt 30 (FIG. 3 to FIG. 5) and a nut 38 (FIG. 5).

The radiator support 13 is coupled to two side panels 61 which are connected to the front side (left side in FIG. 1) of the cab 60 at the upper end sections of both end sections in the vehicle width direction. The two side panels 61 are provided at both of the end sections in the vehicle width direction. The radiator support 13 corresponds to the first component, and the mount members 57 which are connected to the radiator support 13 correspond to the second component. A radiator (not shown) is fixed to the front or rear side of the radiator support 13. The radiator support 13 and the mount members 57 are connected to form the component fastening structure 12.

An engine compartment 62 is formed in an area surrounded by the two side panels 61 between the radiator support 13 and the cab 60. An engine and an auxiliary machine (not shown) are provided in the engine compartment 62.

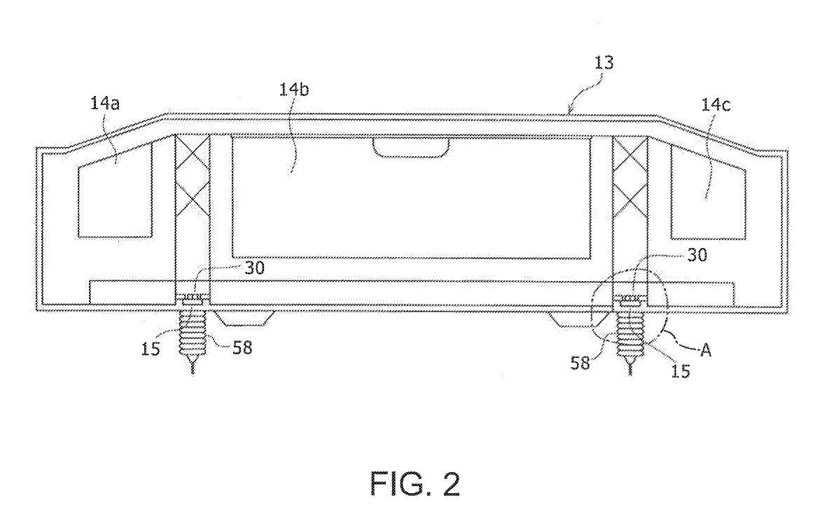

The component fastening structure 12 is described in detail below. FIG. 2 is a view from a back of the vehicle including the radiator support 13, the shock absorbing members 58 and the bolts 30 of FIG. 1. FIG. 3 is a view of point A in FIG. 2 observed obliquely from above.

The component fastening structure 12 is configured by including the radiator support 13, the mount member 57 (FIG. 1), the bolt 30, the nut 38 (FIG. 5), and the shock absorbing member 58. The radiator support 13 has a nearly plate-like shape that is long in the vehicle width direction (in the lateral direction of FIG. 2), and window sections 14a, 14b, 14c are formed at three positions along the vehicle width direction. The radiator (not shown) is opposed to the window section 14b at the center in the vehicle width direction in a state where the radiator is fixed to the radiator support 13. The radiator support 13 is integrally formed of metal. The radiator support 13 may also be integrally formed of resin.

The radiator support 13 includes two lower plate portions 15 which are formed to protrude to the rear side of the vehicle at two positions which are separated in the vehicle width direction at a lower end of the rear side (the front sides of FIG. 2 and FIG. 3) in the vehicle longitudinal direction. The individual lower plate portions 15 are formed with a through hole 16 (FIG. 5) through which a shaft portion of the bolt 30 is vertically inserted. The through hole 16 is a simple circular hole without having a threaded part. As shown in FIG. 3, a seating face 17 is formed on the upper side surfaces of the individual lower plate portions 15 and near the top end opening of the through hole 16. The head 32 of the bolt 30 for connecting the radiator support 13 to the mount member 57 (FIG. 1) is mounted on the seating face 17.

On the individual lower plate portions 15, two first ribs 18 and two second ribs 19 are formed near the seating face 17. The two first ribs 18 are rectangular plate-like wall portions which are formed to protrude upward higher than the seating face 17 on the lower plate portions 15 at both sides in the vehicle width direction (lateral direction in FIG. 3) with the head 32 of the bolt 30 positioned between them. Height H1 of the first rib 18 (FIG. 3) is slightly larger than a thickness of a later-described arm parts 33 formed on the head 32 of the bolt 30. As shown in FIG. 6 described later, when the two first ribs 18 are viewed from above, they are parallel to each other. The above-described arm parts 33 are opposed to surfaces 18a (FIG. 6) of the individual first ribs 18 on the bolt 30 side in the vehicle width direction. The individual first ribs 18 correspond to the rotation preventing wall portions for restricting the rotation of the bolt 30.

The two second ribs 19 are rectangular plate-like parts which are formed respectively on the upper ends of the two first ribs 18 to protrude upward at a position apart above the seating face 17. The individual second ribs 19 are partly protruded toward the head 32 of the bolt 30 more than the surfaces 18a of the first ribs 18 on the bolt 30 side. The individual second ribs 19 are formed continuously to the first ribs 18. Thus, a long groove 20 (FIG. 5) is formed in the vehicle longitudinal direction between the lower surface of the second rib 19 and the seating face 17. As described later, the tip portions of the arm parts 33 formed on the head 32 of the bolt 30 are inserted into the grooves 20. The individual second ribs 19 correspond to lifting suppressing portions for suppressing the head 32 of the bolt 30 from being lifted from the seating face 17.

FIG. 4 is a perspective view of the bolt 30. The bolt 30 includes the shaft portion 31, and the head 32 formed on the top end of the shaft portion 31. The head 32 has a disk part 32a and a hexagonal head body 34 formed on the upper side of the disk part 32a. Two arm parts 33 are formed on the outer peripheral surface of the disk part 32a to protrude in mutually opposite directions on a straight line orthogonal to the axial direction of the bolt 30. The individual arm parts 33 have an approximately rectangular plate-like shape, and their tip portions are formed to have a semicircular shape when observed from above. In addition, the shaft portion 31 of the bolt 30 has a cylindrical outer peripheral surface from the head 32 side end to the intermediate part, and a thread part 31a is formed on the tip portion only of the shaft portion 31.

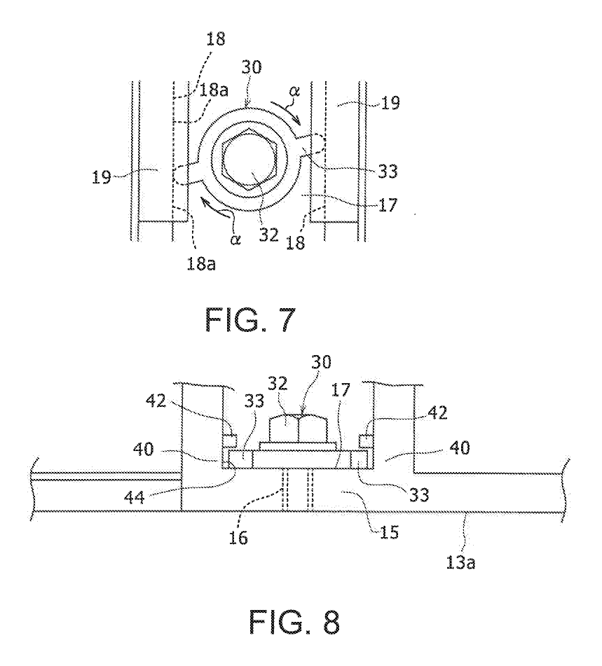

FIG. 5 is an enlarged B-B sectional view of FIG. 1. FIG. 6 is a top view of FIG. 5. FIG. 7 is a view showing a state where the arm parts 33 are engaged with the first ribs 18 when the bolt 30 is rotated in FIG. 6.

As shown in FIG. 5, the mount member 57 is a metal stand formed to have a nearly trapezoidal shape when observed from one side in the vehicle longitudinal direction. The mount member 57 is fixed to the upper side of the front bracket 56 (FIG. 1) by the above-described welding or fastening means. A through hole 57b is vertically formed through a top plate part 57a which is formed at the top end of the mount member 57 and parallel to the horizontal plane. On the upper surface of the top plate part 57a, a cylindrical collar 59 is provided near an opening of the through hole 57b.

The head 32 of the bolt 30 is mounted on the seating face 17 of the radiator support 13, and the shaft portion 31 of the bolt 30 is inserted through the through hole 16 of the lower plate portions 15. Also, a part of the shaft portion 31 of the bolt 30 protruded from a lower surface of the lower plate portions 15 penetrates through the collar 59, then penetrates through the through hole 57b of the top plate part 57a of the mount member 57, and protrudes below the top plate part 57a. In this state, the nut 38 is connected to the thread part 31a of the bolt 30 formed at the part protruded below the top plate part 57a. Thus, the radiator support 13 and the mount member 57 are connected by the bolt 30 and the nut 38. Also, the shock absorbing member 58 is provided outside the collar 59 so as to cover the collar 59 between the lower plate portions 15 and the top plate part 57a of the mount member 57.

The shock absorbing member 58 is formed to have a bellows-like cylinder body made of rubber and elastically stretchable vertically. In a state where the nut 38 connected to the bolt 30, a gap is formed between the top end of the collar 59 and the lower surface of the lower plate portions 15 or between the lower surface of the top plate part 57a of the mount member 57 and the upper surface of the nut 38. Thus, the shock absorbing member 58 is compressed by the radiator support 13 and the mount member 57, thereby the impact applied from the ladder frame 50 (FIG. 1) to the radiator support 13 can be suppressed by the shock absorbing member 58.

In addition, as shown in FIG. 5 and FIG. 6, the tips of the individual arm parts 33 of the bolt 30 are inserted into the grooves 20 between the second ribs 19 and the seating face 17. As shown in FIG. 6, the bolt 30 and the lower plate portions 15 are viewed from above, and a distance L1 between the two first ribs 18 is smaller than a distance L2 between the tips of the two arm parts 33. Thus, as shown in FIG. 7, when the two arm parts 33 are rotated in a direction of arrow a on the seating face 17, the tips of the individual arm parts 33 are engaged with the surfaces 18a of the first ribs 18 so that the rotation of the head 32 of the bolt 30 is restricted.

Further, returning to FIG. 5, the lower sides of the two second ribs 19 which are on the seating face 17 side are opposed to the upper surfaces of the two arm parts 33. At this time, a small space is formed between the lower surfaces of the individual second ribs 19 and the upper surfaces of the arm parts 33. Thus, the head 32 of the bolt 30 is suppressed from being lifted from the seating face 17.

In assembling the above-described component fastening structure 12, the arm parts 33 formed on the head 32 of the bolt 30 are set not to overlay the second ribs 19 when observed from above, as indicated by a chain double-dashed line in FIG. 6, and the head 32 is arranged on the seating face 17 of the lower plate portions 15. In this state, the shaft portion 31 (FIG. 5) of the bolt 30 is inserted from above through the through hole 16 (FIG. 5) of the lower plate portions 15 and the collar 59 (FIG. 5). Also, in the state where the shock absorbing member 58 is arranged outside the collar 59, the tip portion of the shaft portion 31 of the bolt 30 is inserted from above through the through hole 57b of the mount member 57 (FIG. 5). Then, the head 32 of the bolt 30 is turned to insert the tip portions of the two arm parts 33 into the groove 20 under the second ribs 19 as indicated by a solid line in FIG. 6. Also, the radiator support 13 is connected to the mount member 57 by fastening the nut 38 with the shaft portion 31 of the bolt 30 with a tool at the lower side of the mount member 57.

According to the above-described component fastening structure 12, in a case where the bolt 30 turns when the nut 38 is fastened to the bolt 30, the arm parts 33 formed on the head 32 of the bolt 30 are engaged with the first ribs 18. Thus, the bolt 30 is prevented from turning when the nut 38 is fastened to the bolt 30. Since the through hole 16 in the radiator support 13 through which the shaft portion 31 of the bolt 30 is inserted can also be formed to have a small circular hole, rigidity of the lower plate portions 15 including the seating face 17 of the radiator support 13 can be improved. Further, the upper surfaces of the arm parts 33 formed on the head 32 are abutted against the lower sides of the second ribs 19, so that the head 32 can be suppressed from being lifted from the seating face 17. Thus, when the nut 38 is connected to the lower side of the bolt 30, the bolt 30 can be prevented from escaping by being pushed upward, thereby, work of connecting the bolt 30 and the nut 38 is facilitated.

In addition, the radiator support 13 is integrally made of metal or resin and includes the two first ribs 18 and the two second ribs 19 formed continuously to the two first ribs 18. Thus, the number of assembling processes and the number of components for the radiator support 13 can be reduced, and the radiator support 13 can be easily realized to have a structure in which a portion requiring local strength can be made thick. For example, different from the embodiment, it is also considered to form a portion containing the seating face 17 and portions corresponding to the first ribs 18 and the second ribs 19 in the radiator support 13 by welding a plurality of plate materials. In this case, however, the number of assembling processes and the number of components for the radiator support 13 increase considerably.

FIG. 8 is a view of another example of the embodiment and corresponds to the upper part of FIG. 5. The structure of this example is different from the structure of FIG. 1 to FIG. 7. Two wall portions 40 that extend vertically are formed near the seating face 17 of the lower plate portions 15 of the radiator support 13a and at both ends in the vehicle width direction (the lateral direction of FIG. 8). Also, rectangular plate-like projections 42 are formed to wholly protrude toward the head 32 of the bolt 30 at positions apart above the seating face 17 on the surfaces of the individual wall portions 40 on the bolt 30 side. Grooves 44 are formed between the lower surfaces of the projections 42 and the seating face 17, and the tip portions of the arm parts 33 formed on the head 32 of the bolt 30 are inserted into the grooves 44. The individual wall portions 40 correspond to the rotation preventing wall portions, and the individual projections 42 correspond to the lifting suppressing portions.

With the above-described structure, similar to the structure of FIG. 1 to FIG. 7, rigidity of the radiator support 13 where the head 32 of the bolt 30 is provided can be improved, the bolt 30 can be prevented from rotating, and the head 32 is suppressed from being lifted from the radiator support 13. In this example, other configurations and actions are similar to those of FIG. 1 to FIG. 7.

It was described in the above examples that the radiator support 13 is connected to the mount member 57 which is fixed to the front bracket 56 (FIG. 1) by the bolt and the nut. Meanwhile, it is possible to have a configuration where the lower end portion of the bolt is inserted to the lower side through the mount member 57 and is also inserted through the front bracket 56 arranged at the lower side of the mount member 57, and the nut is connected to the lower end portion of the bolt at the lower side of the front bracket 56. With the above configuration, the front bracket, the mount member, and the radiator support are connected by the bolt and the nut. Also, the mount member may be directly fixed to the upper side of the side frame 52 with the front bracket (FIG. 1) omitted, and the radiator support 13 may be connected to the mount member by the bolt and the nut.

In the above examples, the arm parts formed on the head 32 of the bolt 30 are not limited to an approximately rectangular plate-like shape but may be formed into, for example, a mountain-like plate shape.

1. A component fastening structure in which a first component and a second component are mutually connected by a bolt and a nut, wherein:
the first component includes a through hole through which a shaft portion of the bolt is inserted vertically, a seating face on which the head of the bolt is mounted near an upper end opening of the through hole, two rotation preventing wall portions which are formed near the seating face at both sides of the head to position the head between them, and two lifting suppressing portions which are formed at positions apart above the seating face on the two rotation preventing wall portions and protruded at least partly toward the head side;
the bolt includes two arm parts which are formed on the head to protrude in mutually opposite directions on a straight line orthogonal to the axial direction of the bolt;
an interval between the two rotation preventing wall portions is smaller than a distance between tip ends of the two arm parts; and
the seating face sides of the two lifting suppressing portions are opposed to the upper surfaces of the two arm parts.

2. The component fastening structure according to claim 1, wherein:
the first component is integrally made of metal or resin,
the two rotation preventing wall portions are two first ribs formed on the first component, and
the two lifting suppressing portions are two second ribs which are formed continuously to the two first ribs.
